(19) United States
(12) Patent Application Publication
(10) Pub. No.: US 2005/0133433 A1
(43) Pub. Date: Jun. 23, 2005

(54) Sealing mechanism and filter cartridge with improved sealing mechanism

(75) Inventor: Edmond Leveson Rampen, Oakville (CA)

Correspondence Address: TAROLLI, SUNDHEIM, COVELL, & TUMMINO L.L.P., SUITE 1111, 526 SUPERIOR AVENUE, CLEVELAND, OH, 44114-1400, US

(73) Assignee: Envirogard Products Limited

(21) Appl. No.: 10/738,180

(22) Filed: Dec. 17, 2003

(51) Int. Cl. B01D 27/00

(52) U.S. Cl. 210/282; 210/437; 210/460

(57) ABSTRACT

A fluid filtering cartridge comprising a filter element, including a body of filtering media and having a substantially hollow interior in fluid communication with an opening extending through the filtering media, and a sealing element situated in the opening. The sealing element presents a fluid-tight seal between the opening and a conduit received therein. The sealing element comprises a radially inwardly directed flange having an inwardly disposed edge with a ring member secured thereto. The ring member has an interior face sealingly received about the exterior surface of the conduit when the conduit is received within the opening through the filtering media to present a fluid-tight seal between the exterior surface of the conduit and the interior surface of the opening.

### FIELD OF THE INVENTION

This invention relates generally to seals and methods of sealing against a generally cylindrical member. In one embodiment the invention relates to a filter cartridge with an improved seal.

### BACKGROUND OF THE INVENTION

Increasing questions with respect to the purity of the world's fresh water drinking supply have led many consumers to install water filtration systems in their homes and businesses. While there are a large variety of different filtration systems commercially available, one of the most widely used is an in-line filter that separates contaminants from water by passing the water through a filtering media. Most commonly the filtering media is in the form of a generally cylindrically shaped cartridge having a defined pore size. Such filter cartridges are designed with a hollow interior so that raw untreated water is filtered as it passes from the exterior of the cartridge through the filtering media into the hollow interior. At that point the water can be discharged through a tube or pipe inserted into one or both ends of the cartridge. The filtered water can then be directed for consumption or other use.

A primary limitation on the effectiveness of filter cartridges of the type described is the seal that must be developed and maintained between the filter cartridge and the conduit or other means used to extract treated or filtered water from the cartridge's hollow interior. Any failure of that seal can result in untreated water effectively by-passing the filter media and contaminating the treated water, thereby lowering the efficiency of the filter and diminishing the quality and the desirability of the effluent. Of particular concern with respect to the seal used in connection with a water filter cartridge is the fact that once the filter cartridge is in place there is no effective way (short of analyzing the effluent from the filter) to determine whether a seal has been formed and is being maintained. The use of an effective, high integrity seal can thus help to alleviate such concerns.

In order to present a fluid-tight seal in filter cartridges others have proposed the use of gaskets, o-rings and various types of lip seals. While each of these currently available sealing mechanisms has met with varying degrees of success, each also suffers from its own inherent limitations. Simple gaskets are only effective upon the application and maintenance of a sufficient compressive force against the gasket material. Relaxation of that force can result in leakage. Designing a filter cartridge that is capable of applying and maintaining a compressive force against a gasket-type sealing element can sometimes involve a mechanically more complex structure at an increased cost. Further, variables such as cartridge length, the amount of force exerted against the cartridge and gasket by the cartridge housing, and pressure differentials can have an impact on the effectiveness of the seal. While 0-rings present effective means to create a seal between two cylindrical elements, their ability to hold and maintain a seal can be diminished where one or both of the elements are not perfectly cylindrical, which is often the case when dealing with filter cartridges and their housing. O-rings also suffer from the potential of being rolled out of their race when fitted over the end of a pipe or tubular element. Traditional forms of lip seals (such as that described in U.S. Pat. No. 3,675,777, dated Jul. 11, 1972) also tend to be somewhat unaccommodating in instances where parts to be sealed are not right cylinders. Lip seals may also become overturned when inserted over the end of a pipe or conduit, thereby either eliminating the seal or reducing its ability to be maintained under pressure.

### SUMMARY OF THE INVENTION

The invention therefore provides a fluid-tight seal that may be used in a filter cartridge, that is capable of forming and maintaining a seal of high integrity over a wide variety of pressure differentials, and that bestows a high degree of confidence in applications such as water filtration. The seal of the present invention tends to accommodate members that may not be perfectly cylindrical and permits the removal and insertion of a tubular element while maintaining a high integrity seal.

Accordingly, in one of its aspects the invention provides a fluid filtering cartridge comprising a filter element including a body of filtering media and having a substantially hollow interior in fluid communication with an opening extending through said filtering media and, a sealing element situated in said opening, said sealing element presenting a fluid-tight seal between said opening and a conduit received therein, said sealing element comprising a radially inwardly directed flange having an inwardly disposed edge with a ring member secured thereto, said ring member having an interior face sealingly received about the exterior surface of the conduit when the conduit is received within said opening through said filtering media to present a fluid-tight seal between the exterior surface of said conduit and the interior surface of said opening.

In a further aspect the invention provides a filter cartridge for the removal of contaminants from a stream of fluid, said cartridge comprising a filter element including a body of filtering media and having a generally hollow interior in fluid communication with an opening extending through said filtering media, a cylindrical tube fixedly received within said opening, said cylindrical tube having an exterior and an interior surface; and, a sealing element situated within said cylindrical tube, said sealing element comprising a radially inwardly directed flange intersecting and connected to the interior surface of said cylindrical tube, said flange having an inwardly disposed edge with a ring member secured thereto, said ring member having an interior face sealingly receivable about the exterior surface of a conduit inserted through said cylindrical tube to present a fluid-tight seal between the interior surface of said cylindrical tube and the exterior surface of said conduit.

In yet a further aspect the invention provides a sealing element for sealingly engaging the exterior surface of a generally cylindrical body, the sealing element comprising a radially inward directed flange having an inwardly disposed edge with a ring member secured thereto, said ring member having an interior face sealingly receivable about the exterior surface of the generally cylindrical body received through said sealing element, said ring member having a leading edge and a trailing edge, said leading and said trailing edges directed outwardly from said flange, said ring member generally frustoconical in shape with the internal opening through said ring member at said leading edge greater than the internal opening through said ring member at said trailing edge.

The invention also provides for a sealing element for sealingly engaging the interior surface of a bore, said sealing element secured to the exterior surface of an elongate member receivable within said bore and sealing between the exterior surface of said elongate member and the interior surface of said bore upon the receipt of the elongate member therein, the sealing element comprising a radially outward directed flange having an outwardly disposed edge with a ring member secured thereto, said ring member having an exterior face sealingly received against the interior surface of said bore when the elongate member is received therein, said ring member having a leading edge and a trailing edge and being generally frustoconical in shape with said ring member being larger at said trailing edge than at said leading edge.

Further aspects and advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show the preferred embodiments of the present invention in which:

FIG. 1 is a side elevational view of a typical filter cartridge employing the seal of the present invention;

FIG. 2 is a vertical cross sectional view of the middle portion of the upper end of the filter cartridge shown in FIG. 1 received about the end of a pipe or tube to which the filter cartridge may be connected;

FIG. 3 is a vertical section similar to that shown in FIG. 2 wherein the end of the pipe or tube to which the filter cartridge is to be connected is inserted into the filter and is in partial contact with the filter sealing element;

FIG. 4 is a vertical section similar to that shown in FIG. 3 wherein the pipe or tube has been received further into the interior of the filter cartridge and has fully engaged the filter sealing element;

FIG. 5 is a side sectional view similar to that of FIG. 2 showing an alternate configuration of the sealing element of the present invention;

FIG. 6 is a side sectional view of an embodiment of the seal of the present invention engaging the exterior surface of a pipe, tube, conduit or other generally cylindrical member; and,

FIG. 7 is a side sectional view of a further embodiment of the seal of the present invention.

### DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein. For example, it will be appreciated from a thorough understanding of the invention that the sealing mechanism described herein may have application to a very wide variety of different end uses and different mechanical structures. For illustrations purposes, use of the inventive sealing mechanism on a fluid filter cartridge is described below.

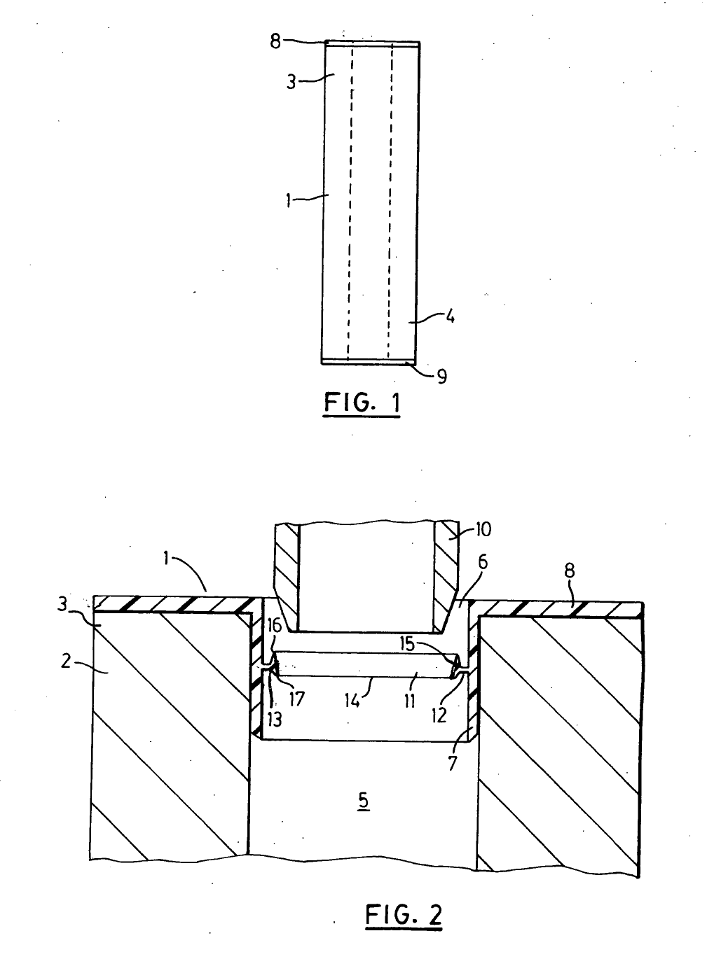

FIG. 1 depicts a fluid filtering cartridge that includes a sealing mechanism constructed in accordance with a preferred embodiment of the present invention. The filter cartridge is of the type that is typically used to filter particulate or other contaminants from a stream of liquid. Commonly such filters are used in association with in-line water filters and may have both residential and commercial application. Filters of this type generally include a cannister or housing, within which the filter cartridge is received, and a filtering head that allows untreated water to enter through an inlet port and filtered or treated water to exit through an outlet port.

The filter cartridge shown in FIG. 1 generally comprises a filter element 1 that includes a body of filtering media 2 in the form of an elongate cylinder having an upper end 3 and a lower end 4. Filtering media 2 may be comprised of a wide variety of different filtering materials including but not limited to cellulose, activated charcoal, ceramic material, a wide variety of plastics, resins and other loose or powdered materials. The particular filtering media to be utilized will be chosen giving consideration to the fluid to be filtered and the nature and size of the contaminants in issue.

Typically filter element 1 has a substantially hollow interior 5 in fluid communication with at least one opening 6 extending through the filtering media. As is shown in FIG. 2, in many applications where filter element 1 is in the form of an elongate cylinder opening 6 is situated in the middle of upper end 3. Depending upon its method of manufacture and the material from which filter element 1 is formed, opening 6 may merely be an opening extending through the filtering media or, alternatively, may be defined by of a cylindrical tube 7 extending into hollow interior 5 and connected to a cap 8 situated about the end of the filtering media. The methods of manufacturing employed to create filtering media 2 most often result in the formation of a cylinder having a hollow bore extending from its upper to its lower end. In such cases lower end 4 of filter element 1 may also be fitted with an end cap and cylindrical tube in a similar fashion to upper end 3. Alternatively, the lower end of the filtering element may be fully enclosed with a solid end cap 9 (see FIG. 1) having no openings or passageways.

Referring to FIGS. 2, 3 and 4, it will be appreciated that fluid passing from the exterior of filtering element 1 into hollow interior 5 will be “filtered” as it travels through media 2 such that particulate and/or other contaminants are removed leaving filtered or treated water occupying hollow interior 5. Filtered water from the hollow interior is extracted by means of a discharge conduit 10 that is received through opening 6 and utilized to remove the filtered fluid and direct it elsewhere for a desired purpose.

To prevent the intermixing of treated and untreated fluid, a sealing element 11 is positioned within opening 6 to seal the gap located between the opening and conduit 10. When conduit 10 is fully received within opening 6 sealing element 11 effectively encloses the radial space between the exterior surface of conduit 10 and the interior surface of either opening 6 or cylindrical tube 7, where a cylindrical tube and end cap are utilized. The establishment and maintenance of a seal within this radial opening ensures that all treated fluid within hollow interior 5 exits through conduit 10, while at the same time prevents untreated fluid exterior to filter media 2 from flowing directly into hollow interior 5 and intermixing with fluid that has been previously treated.

In the preferred embodiment of the invention sealing element 11 comprises a radially inwardly directed flange 12 having an inwardly disposed edge 13 with a ring member 14 secured thereto. In most instances conduit 10 will have a generally circular cross-sectional shape. For that reason ring member 14 is also preferably generally circular in shape, however, it should be noted that depending upon the shape of conduit 10 ring member 14 could be elliptical or a variety of other geometric shapes. Further, it is expected that in most instances flange 12 will also be generally circular in shape. Nevertheless, as in the case of the ring member, in some instances non-circular geometric configurations of flange 12 may be utilized. Regardless, flange 12 is solid with no holes or openings to prevent the passage of fluid therethrough. Ring member 14 has an interior face 15 that is capable of being sealingly received about the exterior surface of conduit 10 when the conduit is placed within opening 6 and adjacent to sealing element 11. Interaction of interior face 15 of ring member 14 and the exterior surface of conduit 10 effectively presents a fluid-tight seal between the exterior surface of the conduit and ring member 14. While it is expected that in most instances face 15 will be generally flat, it could also be concave or faceted.

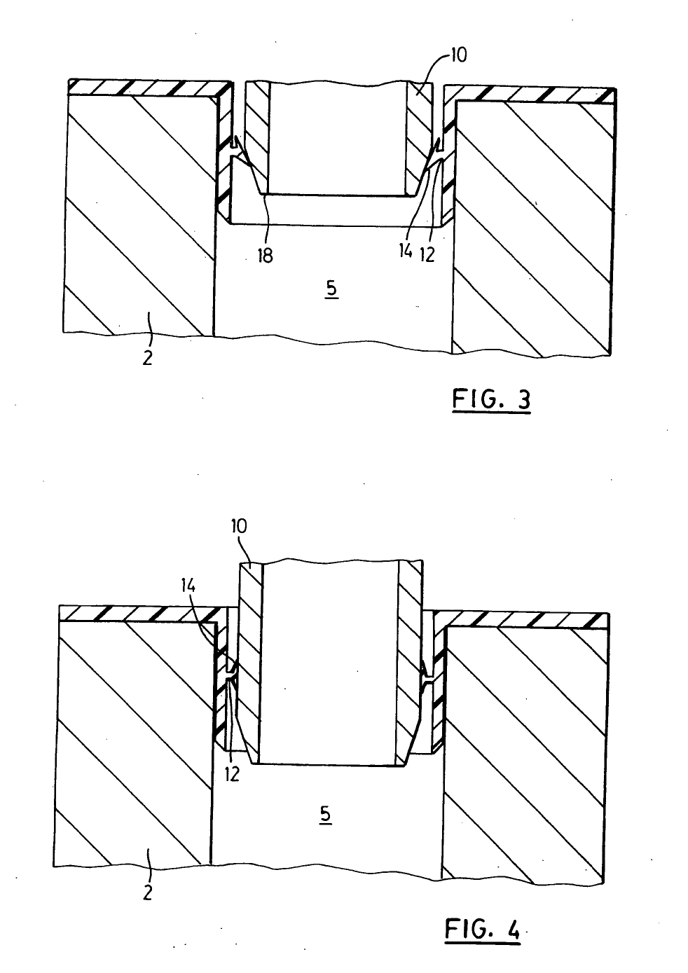

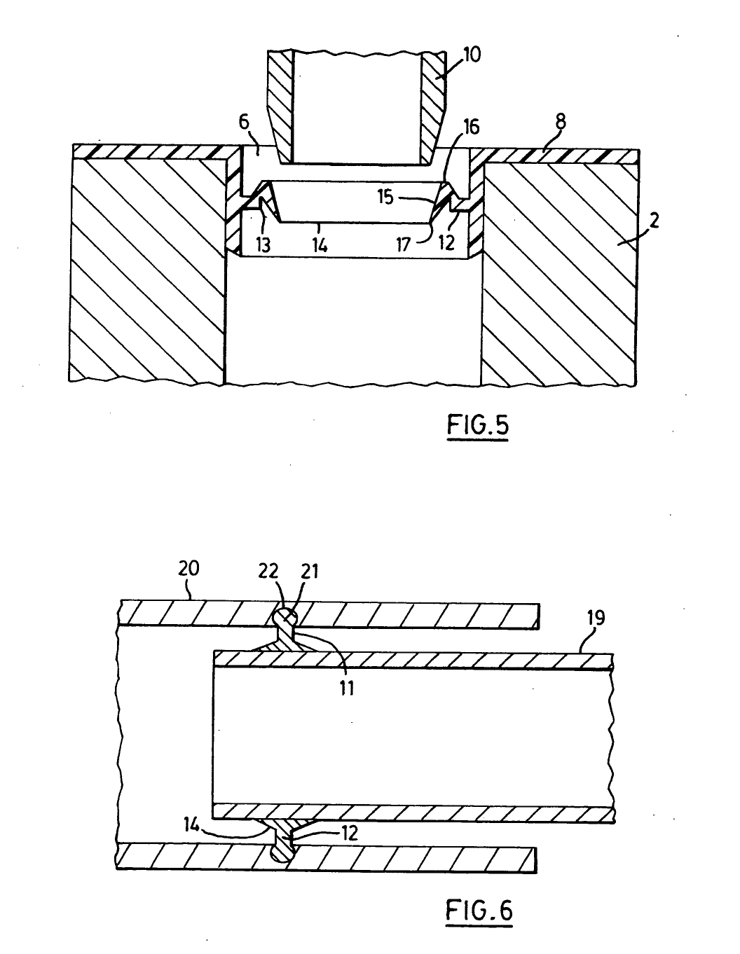

In the embodiment of the invention shown in the attached drawings ring member 14 is generally frustoconical in shape with a leading edge 16 that is directed outwardly from hollow interior 5 and a trailing edge 17 directed inwardly toward hollow interior 5. On account of its frustoconical shape, the inside diameter of ring member 14 at leading edge 16 is greater than the inside diameter of the ring member at its trailing edge 17. As shown (see FIG. 2), leading edge 16 has an interior diameter that is greater than the exterior diameter of conduit 10. By making the diameter of leading edge 16 greater than that of the conduit, when the conduit is inserted into opening 6 its lower end 18 will by-pass leading edge 16 and will come to bear against the ring member part way along interior face 15, between leading edge 16 and trailing edge 17 (see FIG. 3). In this manner there will be no tendency to overturn leading edge 16 when conduit 10 is inserted into opening 6 and into contact with sealing element 11. An alternate physical configuration of ring member 14 is shown in FIG. 5.

Ring member 14 is also preferably constructed such that trailing edge 17 has an interior diameter that is equal to, or preferably less than, the exterior diameter of conduit 10. Where trailing edge 17 is of the same size or slightly smaller than the exterior diameter of the conduit there will be an assurance that once the conduit is fully inserted into opening 6 and past sealing element 11, interior face 15 will engage the outside of the conduit and present a fluid-tight seal. A slightly smaller trailing edge on ring member 14 causes the ring member to be compressed about the conduit when the conduit is inserted therethrough.

Ring member 14 and flange 12 are preferably formed from a flexibly resilient material such as silicone, rubber, polypropylene, polyolefin, or a thermoplastic elastomer. The flexibility and resiliency of both the flange and the ring member enables each component to be deflected as conduit 10 is inserted into opening 6 and into contact with sealing element 11. As is shown in FIG. 3, upon initial contact of lower end 18 of conduit 10 with the interior face of ring member 14, the ring member has a tendency to cant or tilt such that trailing edge 17 is deflected outwardly and leading edge 10 is deflected inwardly toward the centre of opening 6. At the same time, flange 12 tends to be deflected slightly downward. The deflection and tilting of the ring member and flange has the effect of creating a biasing force tending to drive interior face 15 of ring member 14 against the exterior surface of conduit 10. The combination of the flexible resiliency of the flange and ring member, together with the frustoconical shape and dimension of the ring member relative to the exterior diameter of conduit 10, together ensure the creation and maintenance of a high integrity seal. The physical structure of ring member 14 is such that external pressure exerted against the ring member helps to enhance the seal of interior face 15 against the exterior surface of conduit 10.

In the particular embodiment of the invention shown in the attached drawings the width of flange 12 (as measured in a radial direction) is less that the height of ring member 14 (as measured from the point of intersection of the ring member and the flange). This increased area of ring member 14 presents a larger surface against which pressure, exterior to ring member 14, may bear. With this configuration the integrity of the seal between face 15 and conduit 10 is enhanced with an increase in exterior pressure. The relatively small radial surface area of flange 12 will also tend to minimize the likelihood of the flange being displaced by any reasonable pressure differential that may exist between opposite sides of sealing element 11. The small radial area of the flange presents a small surface area against which any pressure differential will bear, and hence minimizes the force applied to the flange.

Since trailing edge 17 has an interior diameter that is preferably less than the exterior diameter of conduit 10, the lower portion of the ring member is effectively stretched over the conduit helping to ensure an effective seal, even under situations of low or zero pressure. Furthermore, the described structure of flange 12 and ring member 14 allows for the seal around the outer surface of conduit 10 to be maintained in the event of a reversal of flow through the filter, as would be the case in a back washing situation.

It will be appreciated that the nature and structure of ring member 14 will enable filter element 1 to be easily removed from conduit 10 and subsequently replaced without significantly affecting the ability of sealing element 11 to perform its intended purpose. The structure and resiliency of the sealing element will remain intact and permits the filtering element to be inserted over the conduit and removed a number of times without any deleterious affects.

In many instances the manufacturing method utilized to create filtering media 2 will necessitate the use of an upper end cap 8 having a cylindrical tube 7 attached thereto. In such cases it is expected that flange 12 and ring member 14 will be of unitary construction with end cap 8 and cylindrical tube 7, and that all four elements will be formed from a flexibly resilient material. Such a situation is shown in each of FIGS. 2 through 4. It should also be noted that in some cases the structure of filter element 1 could be such that flange 12 may be received within a radial channel formed directly in opening 6, without the use of either end cap 8 or cylindrical tube 7.

A further embodiment of the sealing element of the present invention is shown in FIG. 6. Here sealing element 11 is used to seal about the exterior surface of a structure 19 that may be in the form of a pipe, conduit, tube, spigot, boss or similar feature. Structure 19 may form part of a filter cartridge housing or may have an application completely unrelated to filter cartridges. As shown, sealing element 11 forms a seal between structure 19 and a generally cylindrical member 20. It will, however, be appreciated by those skilled in the art that member 20 need not necessarily be cylindrical and may be any other structure that receives a pipe, conduit, tube, spigot, boss or similar item around which it is desired to create and maintain a fluid-tight seal. In the embodiment shown in FIG. 5 sealing element 11 is comprised generally of a flange 12 and a ring member 14. Sealing element 11 is secured directly to cylindrical member 20 through the use of an enlarged outer edge 21 received within a correspondingly shaped channel 22 in cylindrical member 20. Such a structure obviously represents only one of an extremely wide variety of manners in which sealing element 11 may be secured to cylindrical member 20. Other methods may include the use of adhesives and mechanical fasteners. Regardless, the basic overall structure and function of sealing element 11 is the same as described above where the sealing element is incorporated into a filter cartridge.

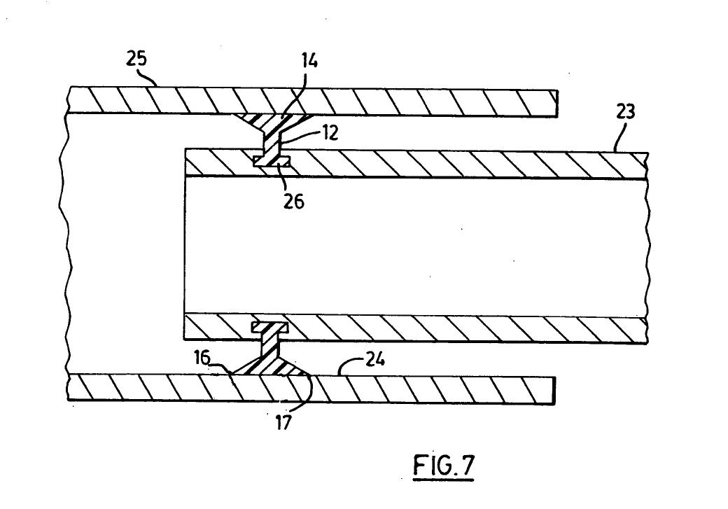

FIG. 7 represents a variation to the embodiment of the invention shown in FIG. 6. In FIG. 6, sealing element 11 is secured to the inside surface of cylindrical member 20 and seals against the outer surface of structure 19. In contrast, it will be noted that in FIG. 7 sealing element 11 is secured to the outer surface of an elongate member 23 and seals against the interior surface of a bore 24. Bore 24 may be the internal passageway thorough a pipe or conduit 25 as shown in FIG. 7 or, alternately, may be essentially any opening in any object or material into which the end of elongate member 23 may be inserted.

In all other aspects the sealing element shown in FIG. 7 functions in generally the same fashion as the sealing element shown in FIGS. 1 through 6. The only structural difference in the embodiment of the sealing element shown in FIG. 7 is that since it seals in an outward fashion against the surface of bore 24, flange 12 is outwardly directed, as is edge 13 and face 15 of ring member 14. It will be appreciated that for leading edge 16 to “lead” into bore 24, in this embodiment ring member 14 is larger at trailing edge 17 and smaller at leading edge 16. The trailing edge of the ring member is also preferably larger than the size of the cross section of bore 24 so that the trailing edge of the ring member will be squeezed into the bore to help enhance the seal that is created.

Finally, in FIG. 7 sealing element 11 is secured to the outer surface of elongate member 23 through the receipt of an inwardly disposed edge 23 within a complimentary shaped channel in member 23. Once again, as in the case of the embodiment shown in FIG. 6, a wide variety of other methods, including through the use of adhesives and mechanical factors, may be used to securely hold the sealing element in place.

It is to be understood that what has been described are the preferred embodiments of the invention and that it may be possible to make variations to these embodiments while staying within the broad scope of the invention. Some of these variations have been discussed while others will be readily apparent to those skilled in the art.

1. A fluid filtering cartridge comprising:
(i) a filter element including a body of filtering media and having a substantially hollow interior in fluid communication with an opening extending through said filtering media; and,
(ii) a sealing element situated in said opening, said sealing element presenting a fluid-tight seal between said opening and a conduit received therein, said sealing element comprising a radially inwardly directed flange having an inwardly disposed edge with a ring member secured thereto, said ring member having an interior face sealingly received about the exterior surface of the conduit when the conduit is received within said opening through said filtering media to present a fluid-tight seal between the exterior surface of said conduit and the interior surface of said opening.

2. The device as claimed in claim 1 wherein said ring member has a leading edge directed outwardly from said hollow interior of said filtering media and a trailing edge directed inwardly toward said hollow interior of said filtering media.

3. The device as claimed in claim 2 wherein said ring member is frustoconical in shape with the inside diameter of said ring member at said leading edge greater than the inside diameter of said ring member at said trailing edge.

4. The device as claimed in claim 1 wherein said ring member and said flange are formed from a flexibly resilient material.

5. The device as claimed in claim 1 wherein said ring member and said flange are formed from plastic, silicone, polyolefin, polyethylene, polypropylene, a thermoplastic elastomer, or rubber.

6. The device as claimed in claim 2 wherein the interior diameter of said leading edge of said ring member is greater than the exterior diameter of said conduit.

7. The device as claimed in claim 6 wherein the interior diameter of said trailing edge of said ring member is less than or equal to the exterior diameter of said conduit, said ring member and said flange deflected when said conduit passes through said ring member, said deflection of said ring member and said flange biasing the interior face of said ring member against the exterior surface of said conduit.

8. The device as claimed in claim 1 wherein said fluid filtering cartridge further includes a cap positioned on the exterior surface of said body of filtering media and about said opening therethrough, said cap including a cylindrical tube received within said opening, said flange of said sealing element connected to the internal surface of said cylindrical tube such that said sealing element presents a fluid-tight seal between the interior surface of said cylindrical tube and the exterior of said conduit when said conduit is received through said cylindrical tube.

9. A filter cartridge for the removal of contaminants from a stream of fluid, said cartridge comprising;
(i) a filter element including a body of filtering media and having a generally hollow interior in fluid communication with an opening extending through said filtering media,
(ii) a cylindrical tube fixedly received within said opening, said cylindrical tube having an exterior and an interior surface; and,
(iii) a sealing element situated within said cylindrical tube, said sealing element comprising a radially inwardly directed flange intersecting and connected to the interior surface of said cylindrical tube, said flange having an inwardly disposed edge with a ring member secured thereto, said ring member having an interior face sealingly receivable about the exterior surface of a conduit inserted through said cylindrical tube to present a fluid-tight seal between the interior surface of said cylindrical tube and the exterior surface of said conduit.

10. The device as claimed in claim 9 wherein said ring member has a leading edge directed outwardly from said hollow interior of said filtering media and a trailing edge directed toward said hollow interior of said filtering media.

11. The device as claimed in claim 10 wherein said ring member is frustoconical in shape with the internal diameter of said leading edge greater than the internal diameter of said trailing edge.

12. The device as claimed in claim 9 wherein said ring member and said flange are formed from a flexibly resilient material.

13. The device as claimed in claim 9 wherein said ring member and said flange are formed from plastic, silicone, polyolefin, polyethylene, polypropylene, a thermoplastic elastomer, or rubber.

14. The device as claimed in claim 9 wherein said cylindrical tube, said flange and said ring member are of unitary construction and formed from a flexibly resilient material.

15. The device as claimed in claim 11 wherein the diameter of said leading edge is greater than the diameter of said conduit received through said cylindrical tube.

16. The device as claimed in claim 15 wherein the interior diameter of said trailing edge of said ring member is less than or equal to the exterior diameter of said conduit, said ring member and said flange deflected when said conduit passes through said sealing element, said deflection of said ring member and said flange biasing the interior face of said ring member against the exterior surface of said conduit.

17. A sealing element for sealingly engaging the exterior surface of a generally cylindrical body, the sealing element comprising a radially inward directed flange having an inwardly disposed edge with a ring member secured thereto, said ring member having an interior face sealingly receivable about the exterior surface of the generally cylindrical body received through said sealing element, said ring member having a leading edge and a trailing edge, said leading and said trailing edges directed outwardly from said flange, said ring member generally frustoconical in shape with the internal opening through said ring member at said leading edge greater than the internal opening through said ring member at said trailing edge.

18. The device as claimed in claim 17 wherein said ring member and said flange are formed from a flexibly resilient material.

19. The device as claimed in claim 17 wherein said ring member and said flange are formed from plastic, silicone, polyolefin polyethylene, polyproprelyne, thermal plastic elastomer, or rubber.

20. The device as claimed in claim 17 wherein the size of the interior opening through said ring member at said trailing edge is less than the size of the cross section of the generally cylindrical body received therethrough.

21. A sealing element for sealingly engaging the interior surface of a bore, said sealing element secured to the exterior surface of an elongate member receivable within said bore and sealing between the exterior surface of said elongate member and the interior surface of said bore upon the receipt of the elongate member therein, the sealing element comprising a radially outward directed flange having an outwardly disposed edge with a ring member secured thereto, said ring member having an exterior face sealingly received against the interior surface of said bore when the elongate member is received therein, said ring member having a leading edge and a trailing edge and being generally frustoconical in shape with said ring member being larger at said trailing edge than at said leading edge.

22. The device as claimed in claim 21 wherein said ring member and said flange are formed from a flexibly resilient material.

23. The device as claimed in claim 21 wherein said ring member and said flange are formed from plastic, silicone, polyolefin, polyethylene, polypropylene, thermoplastic elastomer, or rubber.

24. The device as claimed in claim 21 wherein said ring member, at its trailing edge, is greater in size than the size of the cross section of said bore.

25. The device as claimed in claim 21 wherein said flange includes an inwardly disposed edge received within a complimentary shaped channel in the exterior surface of said elongate member.
